(19) United States
(12) Patent Application Publication
(10) Pub. No.: US 2016/0163096 A1
(43) Pub. Date: Jun. 9, 2016

(54) COMPUTING DEVICE AND METHOD FOR PROCESSING POINT CLOUDS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XIN-YUAN WU, Shenzhen (CN); CHIH-KUANG CHANG, New Taipei (TW); PENG XIE, Shenzhen (CN)

(21) Appl. No.: 14/689,499

(22) Filed: Apr. 17, 2015

(30) Foreign Application Priority Data
Dec. 3, 2014 (CN) 201410722204.6

(51) Int. Cl. G06T 17/00; G06T 5/00; G06T 15/10; G06T 7/00

(52) U.S. Cl. CPC G06T 17/00; G06T 7/0034; G06T 5/002; G06T 15/10; G06T 2207/10028; G06T 2210/56; G06T 2207/20076

(57) ABSTRACT

A computing device and a method of processing point clouds of an object. Two groups of point clouds are jointed initially to form first jointed point clouds. An overlap area of the first jointed point clouds is identified and fitted to two curved surfaces. The method calculates initial correspondence points in the two groups of point clouds and obtains two sets of initial correspondence points. Abnormal points in two sets of initial correspondence points are deleted to obtain two sets of updated correspondence points. The method calculates a conversion relationship between the two groups of point clouds and calculates a least square solution corresponding to the conversion relationship. The method further converts one group of point clouds according to the conversion relationship, and joints the converted group of point clouds with another group of point clouds to be second jointed point clouds.

### CROSS-REFERENCE TO RELATED APPLICATIONS

This application claims priority to Chinese Patent Application No. 201410722204.6 filed on Dec. 3, 2014, the contents of which are incorporated by reference herein.

### FIELD

The subject matter herein relates to point clouds technology, and particularly to a computing device and a method for processing point clouds of an object.

### BACKGROUND

A measurement device can measure a plurality of groups of incomplete point clouds by scanning a surface of an object (e.g., a component of a mobile phone). The groups of incomplete point clouds can be jointed to generate a complete point clouds of the object. However, the generation of the complete point clouds is complicated.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 is a block diagram of an example embodiment of a point cloud processing system included in the computing device of FIG. 1.

FIG. 3 is a flowchart of an example embodiment of a method for processing point clouds.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

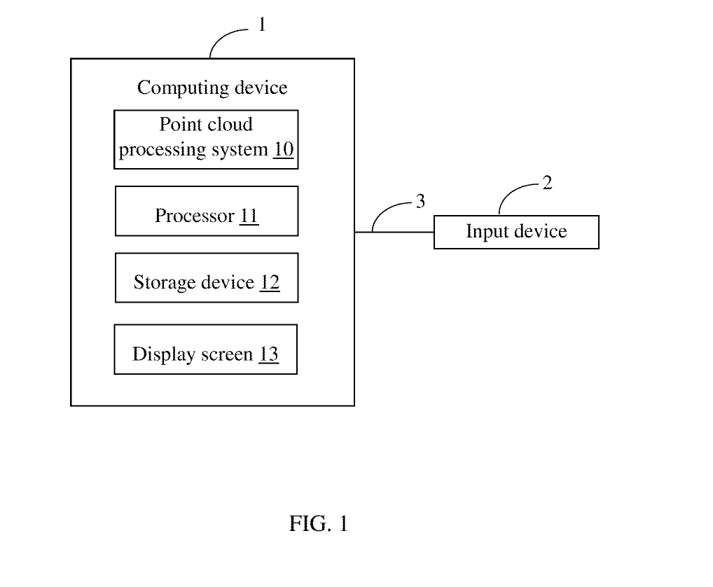

FIG. 1 illustrates a block diagram of an example embodiment of a computing device. In at least one embodiment as shown in FIG. 1, a computing device 1 can include, but is not limited to, a point cloud processing system 10, at least one processor 11, a storage device 12, and a display screen 13. The at least one processor 11 executes one or more computerized codes and other applications of the computing device 1 to provide functions of the point cloud processing system 10. The storage device 12 can be an internal storage device, such as a random access memory (RAM) for temporary storage of information, and/or a read only memory (ROM) for permanent storage of information. The storage device 12 can also be an external storage device, such as an external hard disk, a storage card, or a data storage medium. The display screen 13 can display data of the computing device 1.

In at least one embodiment, the computing device 1 is connected to an input device 2 through a data cable 3. The input device 2 can be a keyboard or a mouse. FIG. 1 illustrates only one example of the computing device 1, and other examples can comprise more or fewer components than those shown in the embodiment, or have a different configuration of the various components. In at least one embodiment, the point cloud processing system 10 can joint two groups of point clouds precisely by extracting correspondence points of the first group of point clouds and the second group of point clouds.

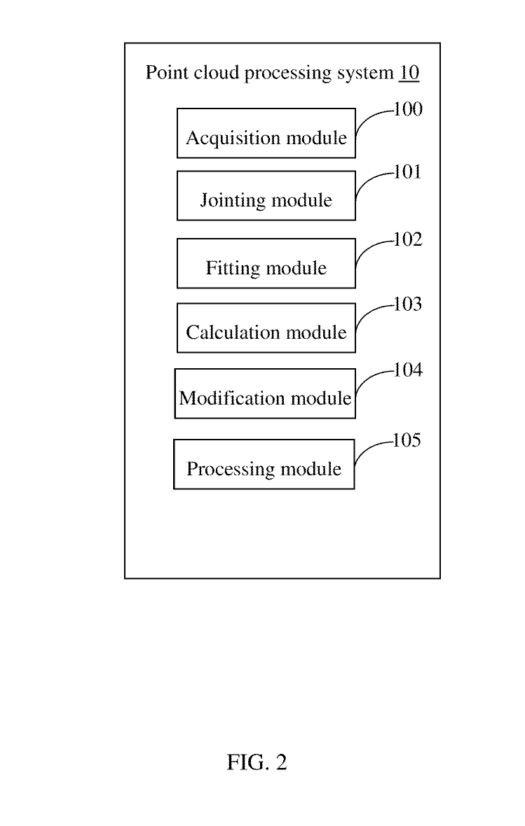

FIG. 2 illustrates a block diagram of an example embodiment of the point cloud processing system in the computing device. In at least one embodiment, the point cloud processing system 10 can include, but is not limited to, an acquisition module 100, a jointing module 101, a fitting module 102, a calculation module 103, a modification module 104, and a processing module 105. The modules 100-105 can include computerized instructions in the form of one or more computer-readable programs that can be stored in a non-transitory computer-readable medium, such as the storage device 12, and be executed by the at least one processor 11 of the computing device 1.

The acquisition module 100 acquires a first group of point clouds and a second group of point clouds of an object from the storage device 12. In at least one embodiment, the storage device 12 can store a plurality of groups of point clouds of one object which can be integrated to form a complete point clouds of the object. The acquisition module 100 first selects two groups of point clouds of the object which are required to be jointed. After the first group of point clouds and the second group of point clouds are jointed completely, the acquisition module 100 continuously selects another group of point clouds in the storage device 12 to be jointed with the above jointed point clouds, until all groups of point clouds of the object have been jointed to form the complete point clouds of the object.

The acquisition module 100 further predetermines a preset precision value. In at least one embodiment, the preset precision value can be predetermined according to user input. For example, an user can input the preset precision value using the input device 2 according to a precision requirement of jointing the first group of point clouds and the second group of point clouds.

The jointing module 101 joints the first group of point clouds and the second group of point clouds initially to form first jointed point clouds. In at least one embodiment, the first group of point clouds and the second group of point clouds can be jointed initially by executing a manual jointing method or a coarse jointing method to align the first group of point clouds and the second group of point clouds approximately. The manual jointing method represents that the user can align the first group of point clouds and the second group of point clouds by manual operations. The coarse jointing method can be a turntable method, a labeling method, for example. In order to initially joint the first group of point clouds and the second group of point clouds quickly, the jointing module 101 can filter the first group of point clouds and the second group of point clouds by removing noise points of the first and the second groups of point clouds before jointing the first group of point clouds and the second group of point clouds.

The fitting module 102 identifies an overlap area of the first jointed point clouds where the first group of point clouds overlaps with the second group of point clouds, and fits two pieces of point clouds on the overlap area (for example, partial point clouds of the first group of point clouds and the second group of point clouds) to a first curved surface and a second curved surface. In at least one embodiment, the fitting module 102 fits the two pieces of point clouds of the overlap area according to a cubic spline surface fitting method and a Quasi-Newton iterative method.

In at least one embodiment, the cubic spline surface fitting method includes a preset equation of

$$'' S ( u , v ) = {\sum }_{i = 0}^{m} {\sum }_{n = 0}^{n} {N}_{ik} ( u ) {N}_{jl} ( v ) {b}_{ij} '' .$$

In the preset equation, “S(u , v)” represents the curved surface, “Nᵢₖ” and “Nⱼₗ” represent continuous first-order derivative and second-order derivative. The fitting module 102 can preset the curved surface “S(u, v)” and a point “M”, and a distance “V” between the point “M” and an arbitrary point “C(u, v)” on the curved surface “S(u, v)” can be represented as a formula of “V(u, v)=C(u, v)−M”. In order to acquire a solution when “V(u, v)” is least, the fitting module 102 uses a Jacobian matrix and partial derivatives of the curved surface “S(u, v)” for executing the Quasi-Newton iterative method, for example, using “k=−Jₛ*(Sᵤ, Sᵥ)” as an iteration step to execute the iterative method.

The calculation module 103 calculates initial correspondence points in the first group of point clouds and the second group of point clouds according to the first curved surface and the second curved surface, and obtains a first set of initial correspondence points and a second set of initial correspondence points. In at least one embodiment, the calculation module 103 uses a rectangle to surround the overlap area, and divides the rectangle into a plurality of sub-rectangles. The calculation module 103 determines two projective points on the first curved surface and the second curved surface projected by a center point of each sub-rectangle, and determines the two projective points corresponding to each sub-rectangle as a pair of correspondence points. The calculation module 103 obtains the first set of initial correspondence points and the second set of initial correspondence points in the first group of point clouds and the second group of point clouds according to the pair of correspondence points of each sub-rectangle.

The modification module 104 obtains a first set of updated correspondence points and a second set of updated correspondence points by deleting abnormal points in the first set of initial correspondence points and the second set of initial correspondence points according to a preset rule. In at least one embodiment, the preset rule includes calculating a distance between each pair of the correspondence points in the first set of initial correspondence points and the second set of initial correspondence points, and deleting a selected pair of the correspondence points from the first set of initial correspondence points and the second set of initial correspondence points when a distance between the selected pair of the correspondence points is larger than or equal to a preset threshold value.

For example, if the first set of initial correspondence points of the first group of point clouds is represented as “P”, and the second set of initial correspondence points of the second group of point clouds is represented as “Q”. Each set of “P” and “Q” includes a number of “n” points. The modification module 104 determines a standard deviation of

$$'' D = \frac{1}{n} {\sum }_{i = 1}^{n} {‖ {P}_{i} - {Q}_{i} ‖}_{2}^{2 } ''$$

as the preset threshold value. Therefore, the modification module 104 determines the pair of the correspondence points which match a condition of “∥Pᵢ−Qᵢ∥₂²≧D” as the abnormal points, and deletes the abnormal points. That is, the modification module 104 reserves the pair of the correspondence points which match a condition of “∥Pᵢ−Qᵢ∥₂²<D” in the first set of initial correspondence points and the second set of initial correspondence points as the first updated set of correspondence points and the second updated set of correspondence points.

The calculation module 103 further calculates a conversion relationship between the first group of point clouds and the second group of point clouds by executing a least square method based on the first and the second updated sets of correspondence points, and calculates a least square solution of an objective function corresponding to the conversion relationship. In at least one embodiment, if the first updated set of correspondence points and the second updated set of correspondence points are represented as “P(aₓ, a_{y}, a_{z}, 1)” and “Q(bₓ, b_{y}, b_{z}, 1)” respectively, and an ideal conversion relationship between the first group of point clouds and the second group of point clouds is represented as “P*T=Q,” which is a super linear equation and has a least square solution. “T” represents a 4*3 transition matrix. An objective function corresponding to the conversion relationship is represented as

$$'' f = {\sum }_{i = 1}^{n} {‖ P * T - Q ‖}^{2} '' .$$

A coordinate relationship between each pair of correspondence points in the first updated set of correspondence points and the second updated set of correspondence points can be represented as “A*T=B”, and “A”, “B” are represented by the following equations:

$$A = [ \begin{matrix}{a}_{x 1} & {a}_{y 1} & {a}_{z 1} & 1 \\ {a}_{x 2} & {a}_{y 2} & {a}_{z 2} & 1 \\ ⋮ & ⋮ & ⋮ & ⋮ \\ {a}_{xn} & {a}_{yn} & {a}_{zn} & 1\end{matrix} ] , \\ and$$

$$B = [ \begin{matrix}{b}_{x 1} & {b}_{y 1} & {b}_{z 1} & 1 \\ {b}_{x 2} & {b}_{y 2} & {b}_{z 2} & 1 \\ ⋮ & ⋮ & ⋮ & ⋮ \\ {a}_{xn} & {a}_{yn} & {a}_{zn} & 1\end{matrix} ] .$$

If “X₀” matches an equation of “∥AX₀−B∥₂=min∥AX₀−B∥₂”, “X₀” is the least square solution, and a general solution is represented as “X=A⁺B+(I−A⁺A)Y”. The minimum value of the least square solution is unique. Therefore, an equation of “X₀=A⁺B” is obtained, and “A⁺” represents generalized inverse of “A”. The calculation module 103 determines “ε=∥AX₀−B∥” as the least square solution of the objective function, and the value of the least square solution represents a precision.

The processing module 105 determines whether the calculated least square solution is less than or equal to the preset precision value. If the calculated least square solution is less than or equal to the preset precision value, the processing module 105 further converts first group of point clouds according to the conversion relationship calculated based on the calculated least square solution, and joints the converted first group of point clouds with the second group of point clouds to form second jointed point clouds, and outputs the second jointed point clouds to be displayed on the display screen 13. If the calculated least square solution is greater than the preset precision value, the fitting module 102 continuously executes the iterative method to fit the curved surfaces, and recalculates the least square solution of the objective function corresponding to the conversion relationship until the calculated least square solution is less than or equal to the preset precision value.

In at least one embodiment, before outputting the second jointed point cloud, the processing module 105 can simplify an overlap area of the second jointed point clouds where the converted first group of point clouds overlaps with the second group of point clouds by executing preset simplification methods, and smooth the overlap area of the second jointed point clouds by executing preset smoothing methods.

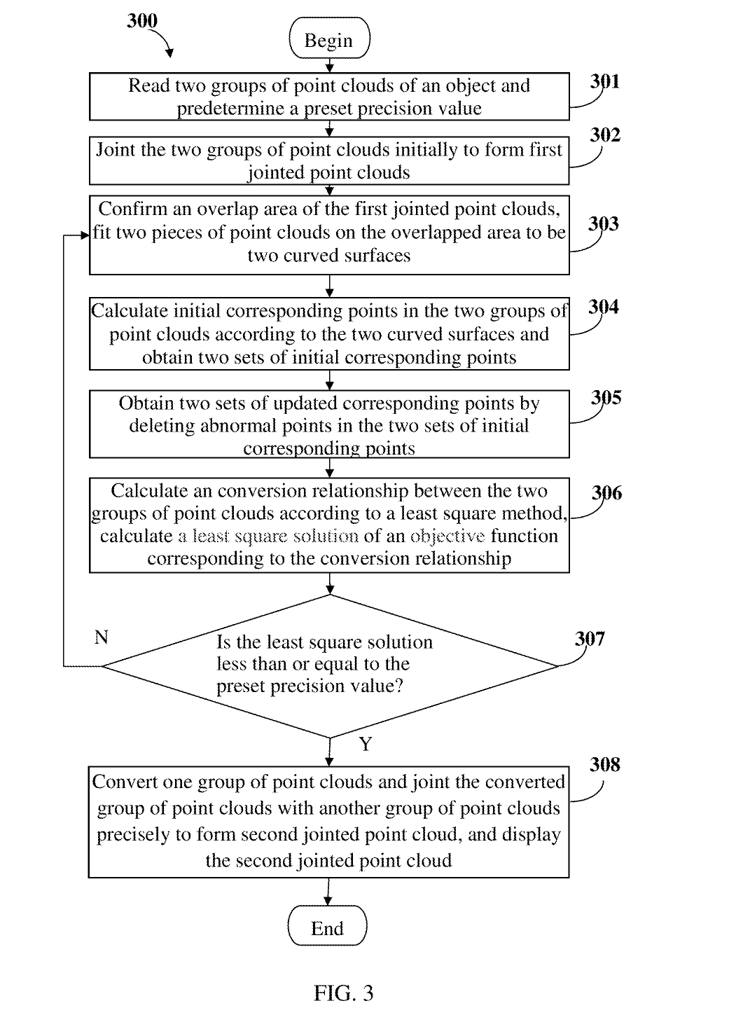

FIG. 3 illustrates a flowchart of an example embodiment of a method for processing point clouds. In an example embodiment, the method is performed by execution of computer-readable software program codes or instructions by at least one processor of a computing device.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining example method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 301.

At block 301, an acquisition module acquires a first group of point clouds and a second group of point clouds of an object from the storage device 12, and predetermines a preset precision value. In at least one embodiment, the storage device 12 can store a plurality of groups of point clouds of one object which can be integrated to form a complete point clouds of the object. The acquisition module first selects two groups of point clouds of the object which is required to be jointed. After the above two groups of point clouds are completely jointed, the acquisition module continuously selects one group of point clouds to be jointed with the above jointed point clouds, until all groups of point clouds of the object have been jointed to form a complete point clouds of the object. In at least one embodiment, the preset precision value can be predetermined according to user input. For example, a user can input the preset precision value using the input device 2 according to a precision requirement of jointing the first group of point clouds and the second group of point clouds.

At block 302, a jointing module joints the first group of point clouds and the second group of point clouds initially to form first jointed point clouds. In at least one embodiment, the first group of point clouds and the second group of point clouds can be jointed initially by executing a manual jointing method or a coarse jointing method to align the first group of point clouds and the second group of point clouds approximately. The manual jointing method represents that the user can align the first group of point clouds and the second group of point clouds manually. The coarse jointing method can be a turntable method, a labeling method, for example. In order to initially joint the first group of point clouds and the second group of point clouds quickly, the joint module 101 can filter the first group of point clouds and the second group of point clouds by removing noise points of the first group of point clouds and the second group of point clouds before jointing the first group of point clouds and the second group of point clouds.

At block 303, a fitting module identifies an overlap area of the first jointed point clouds where the first group of point clouds overlaps with the second group of point clouds, and fits two pieces of point clouds on the overlap area (for example, partial point clouds of the first group of point clouds and the second group of point clouds) to a first curved surface and a second curved surface. In at least one embodiment, the fitting module 102 fits the point clouds of the overlap area according to a cubic spline surface fitting method and a Quasi-Newton iterative method.

In at least one embodiment, the cubic spline surface fitting method includes a preset equation of

$$'' S ( u , v ) = {\sum }_{i = 0}^{m} {\sum }_{n = 0}^{n} {N}_{ik} ( u ) {N}_{jl} ( v ) {b}_{ij} '' .$$

In the preset equation, “S(u, v)” represents the curved surface, “Nᵢₖ” and “Nⱼₗ” represent continuous first-order derivative and second-order derivative. The fitting module 102 can preset the curved surface “S(u, v)” and a point “M”, and a distance “V” between the point “M” and an arbitrary point “C(u, v)” on the curved surface “S(u,v)” can be represented as a formula of “V(u,v)=C(u,v)−M)”. In order to acquire a solution when “V(u, v)” is least, the fitting module 102 uses a Jacobian matrix and partial derivatives of the curved surface “S(u, v)” for executing the Quasi-Newton iterative method, for example, using “k=−Jₛ*(Sᵤ, Sᵥ)” as an iteration step to execute the iterative method.

At block 304, a calculation module calculates initial correspondence points in the first group of point clouds and the second group of point clouds according to the first curved surface and the second curved surface, and obtains a first set of initial correspondence points and a second set of initial correspondence points. In at least one embodiment, the calculation module 103 uses a rectangle to surround the overlap area, and divides the rectangle into a plurality of sub-rectangles. The calculation module 103 determines two projective points on the first curved surface and the second curved surface projected by a center point of each sub-rectangle, and determines the two projective points corresponding to each sub-rectangle as a pair of correspondence points. The calculation module 103 obtains the first set of initial correspondence points and the second set of initial correspondence points in the first group of point clouds and the second group of point clouds according to the pair of correspondence points of each sub-rectangle.

At block 305, a modification module obtains a first set of updated correspondence points and a second set of updated correspondence points by deleting abnormal points in the first set of initial correspondence points and the second set of initial correspondence points according to a preset rule. In at least one embodiment, the preset rule includes calculating a distance between each pair of the correspondence points in the first set of initial correspondence points and the second set of initial correspondence points, and deleting a selected pair of the correspondence points from the first set of initial correspondence points and the second set of initial correspondence points when a distance between the selected pair of the correspondence points is larger than or equal to a preset threshold value.

At block 306, the calculation module further calculates a conversion relationship between the first group of point clouds and the second group of point clouds by executing a least square method based on the first updated set of correspondence points and the second updated set of correspondence points, and calculates a least square solution of an objective function corresponding to the conversion relationship. In at least one embodiment, if the first updated set of correspondence points and the second updated set of correspondence points are represented as “P(aₓ, a_{y}, a_{z}, 1)” and “Q(bₓ, b_{y}, b_{z}, 1)” respectively, and an ideal conversion relationship between the first group of point clouds and the second group of point clouds is represented as “P*T=Q,” which is a super linear equation and has a least square solution. “T” represents a 4*3 transition matrix. An objective function corresponding to the conversion relationship is represented as

$$'' f = {\sum }_{i = 1}^{n} {‖ P * T - Q ‖}^{2} '' .$$

A coordinate relationship between each pair of correspondence points in the first updated set of correspondence points and the second updated set of correspondence points can be represented as “A*T=B”, and “A”, “B” are represented by the following equations:

$$A = [ \begin{matrix}{a}_{x 1} & {a}_{y 1} & {a}_{z 1} & 1 \\ {a}_{x 2} & {a}_{y 2} & {a}_{z 2} & 1 \\ ⋮ & ⋮ & ⋮ & ⋮ \\ {a}_{xn} & {a}_{yn} & {a}_{zn} & 1\end{matrix} ] , \\ and$$

$$B = [ \begin{matrix}{b}_{x 1} & {b}_{y 1} & {b}_{z 1} & 1 \\ {b}_{x 2} & {b}_{y 2} & {b}_{z 2} & 1 \\ ⋮ & ⋮ & ⋮ & ⋮ \\ {a}_{xn} & {a}_{yn} & {a}_{zn} & 1\end{matrix} ] .$$

If “X₀” matches an equation of “∥AX₀−B∥₂=min∥AX₀−B∥₂”, “X₀” is the least square solution, and a general solution is represented as “X=A⁺B+(I−A⁺A)Y”. The minimum value of the least square solution is unique. Therefore, an equation of “X₀=A⁺B” is obtained, and “A⁺” represents generalized inverse of “A”. The calculation module 103 determines “ε=∥AX₀−B∥” as the least square solution of the objective function, and the value of the least square solution represents a precision.

At block 307, a processing module determines whether the calculated least square solution is less than or equal to the preset precision value. If the calculated least square solution is less than or equal to the preset precision value, block 308 is implemented. If the calculated least square solution is greater than the preset precision value, block 303 is repeated to continuously execute the iterative method to fit the curved surfaces.

At block 308, the processing module further converts first group of point clouds according to the conversion relationship calculated based on the calculated least square solution, and joints the converted group of point clouds with another group of point clouds to be second jointed point clouds, and outputs the second jointed point clouds to be displayed on the display screen 13.

All of the processes described above can be embodied in, and fully automated via, functional code modules executed by one or more general purpose processors such as the processor 11. The code modules can be stored in any type of non-transitory readable medium or other storage device such as the storage device 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computing device comprises:
at least one processor; and
a storage device that stores one or more programs which, when executed by the at least one processor, cause the at least one processor to:
acquire a first group of point clouds and a second group of point clouds of an object from the storage device;
joint the first group of point clouds and the second group of point clouds initially to form first jointed point clouds;
identify an overlap area of the first jointed point clouds where the first group of point clouds overlaps with the second group of point clouds, and fit two pieces of point clouds on the overlap area to a first curved surface and a second curved surface;
calculate initial correspondence points in the first group of point clouds and the second group of point clouds according to the first curved surface and the second curved surface, and obtain a first set of initial correspondence points and a second set of initial correspondence points;
delete, according to a preset rule, abnormal points in the first set of initial correspondence points and the second set of initial correspondence points, and obtaining a first updated set of correspondence points and a second updated set of correspondence point;
calculate, by a least square method based on the first updated set of correspondence points and the second updated set of correspondence points, a conversion relationship between the first group of point clouds and the second group of point clouds, and calculate a least square solution of an objective function corresponding to the conversion relationship;
convert the first group of point clouds according to the conversion relationship calculated based on the calculated least square solution when the calculated least square solution is less than or equal to a preset precision value, and joint the converted first group of point clouds with the second group of point clouds to form second jointed point clouds; and
display the second jointed point clouds on a display screen of the computing device.

2. The computing device of claim 1, wherein the first group of point clouds and the second group of point clouds are jointed initially by executing a manual jointing method or a coarse jointing method for aligning the first group of point clouds and the second group of point clouds approximately.

3. The computing device of claim 1, wherein the two pieces of point clouds on the overlap area are fitted according to a cubic spline surface fitting method and a Quasi-Newton iterative method.

4. The computing device of claim 1, wherein the first set of initial correspondence points and the second set of initial correspondence points are obtained by:
using a rectangle to surround the overlap area, and dividing the rectangle into a plurality of sub-rectangles;
determining two projective points on the first curved surface and the second curved surface projected by a center point of each of the plurality of sub-rectangles, and determining two projective points corresponding to each of the plurality of sub-rectangle as a pair of correspondence points; and
obtaining the first set of initial correspondence points and the second set of initial correspondence points in the first group of point clouds and the second group of point clouds according to the pair of correspondence points of each of the plurality of sub-rectangle.

5. The computing device of claim 4, wherein the preset rule comprises calculating a distance between each pair of the correspondence points in the first set of initial correspondence points and the second set of initial correspondence points, and deleting a specified pair of the correspondence points from the first set of initial correspondence points and the second set of initial correspondence points when a distance between the specified pair of the correspondence points is larger than or equal to a preset threshold value.

6. The computing device of claim 1, wherein the at least one processor further comprises:
identifies an overlap area of the second jointed point clouds where the converted first group of point clouds overlaps with the second group of point clouds; and
simplifies and smoothes the overlap area of the second jointed point clouds by executing preset simplification methods and preset smoothing methods before displaying the second jointed point clouds on the display screen.

7. A computer-based method for processing point clouds using a computing device and executable by at least one processor of the computing device, the method further comprises:
acquiring, from a storage device of the computing device, a first group of point clouds and a second group of point clouds of an object;
jointing the first group of point clouds and the second group of point clouds initially to form first jointed point clouds;
identifying an overlap area of the first jointed point clouds where the first group of point clouds overlaps with the second group of point clouds, and fitting two pieces of point clouds on the overlap area to be a first curved surface and a second curved surface;
calculating initial correspondence points from the first group of point clouds and the second group of point clouds according to first curved surface and the second curved surface, and obtaining a first set of initial correspondence points and a second set of initial correspondence points;
deleting, according to a preset rule, abnormal points in the first set of initial correspondence points and the second set of initial correspondence points, and obtaining a first updated set of correspondence points and a second updated set of correspondence points;
calculating, by a least square method based on the first updated set of correspondence points and the second updated set of correspondence points, a conversion relationship between the first group of point clouds and the second group of point clouds, and calculating a least square solution of an objective function corresponding to the conversion relationship;
converting the first group of point clouds according to the conversion relationship calculated based on the calculated least square solution when the calculated least square solution is less than or equal to a preset precision value, and jointing the converted first group of point clouds with the second group of point clouds to form second jointed point clouds;
displaying the second jointed point clouds on a display screen of the computing device.

8. The method of claim 7, wherein the first group of point clouds and the second group of point clouds are jointed initially by executing a manual jointing method or a coarse jointing method for aligning the first group of point clouds and the second group of point clouds approximately.

9. The method of claim 7, wherein the two pieces of point clouds on the overlap area are fitted according to a cubic spline surface fitting method and a Quasi-Newton iterative method.

10. The method of claim 7, wherein the first set of initial correspondence points and the second set of initial correspondence points are obtained by:
using a rectangle to surround the overlap area, and dividing the rectangle into a plurality of sub-rectangles;
determining two projective points on the first curved surface and the second curved surface projected by a center point of each of the plurality of sub-rectangles, and determining the two projective points corresponding to each of the plurality of sub-rectangle as a pair of correspondence points;
obtaining the first set of initial correspondence points and the second set of initial correspondence points in the first group of point clouds and the second group of point clouds, according to the pair of correspondence points of each of the plurality of sub-rectangle.

11. The method of claim 10, wherein the preset rule comprises calculating a distance between each pair of the correspondence points in the first set of initial correspondence points and the second set of initial correspondence points, and deleting the pair of the correspondence points from the first set of initial correspondence points and the second set of initial correspondence points when the distance between the pair of the correspondence points is larger than or equal to a preset threshold value.

12. The method of claim 7, further comprises:
identifying an overlap area of the second jointed point clouds where the converted first group of point clouds overlaps with the second group of point clouds;
simplifying and smoothing the overlap area of the second jointed point clouds by executing preset simplification methods and preset smoothing methods before displaying the second jointed point clouds on the display screen.

13. A non-transitory computer-readable medium having stored thereon instructions that, when executed by at least one processor of a computing device, causing the computing device to perform a method for processing point clouds, the method comprises:
acquiring, from a storage device of the computing device, a first group of point clouds and a second group of point clouds of an object;
jointing the first group of point clouds and the second group of point clouds to form first jointed point clouds initially;
identifying an overlap area of the first jointed point clouds where the first group of point clouds overlaps with the second group of point clouds, and fitting two pieces of point clouds on the overlap area to be a first curved surface and a second curved surface;
calculating initial correspondence points from the first group of point clouds and the second group of point clouds according to first curved surface and the second curved surface, and obtaining a first set of initial correspondence points and a second set of initial correspondence points;
deleting, according to a preset rule, abnormal points in the first set of initial correspondence points and the second set of initial correspondence points, and obtaining a first updated set of correspondence points and a second updated set of correspondence points;
calculating, by a least square method based on a first updated set of correspondence points and the second updated set of correspondence points, a conversion relationship between the first group of point clouds and the second group of point clouds, and calculating a least square solution of an objective function corresponding to the conversion relationship;
converting the first group of point clouds according to the conversion relationship calculated based on the calculated least square solution when the calculated least square solution is less than or equal to a preset precision value, and jointing the converted first group of point clouds with the second group of point clouds to form second jointed point clouds;
displaying the second jointed point clouds on a display screen of the computing device.

14. The non-transitory computer-readable medium of claim 13, wherein the first group of point clouds and the second group of point clouds are jointed initially by executing a manual jointing method or a coarse jointing method for aligning the first group of point clouds and the second group of point clouds approximately.

15. The non-transitory computer-readable medium of claim 13, wherein the two pieces of point clouds on the overlap area are fitted according to a cubic spline surface fitting method and a Quasi-Newton iterative method.

16. The non-transitory computer-readable medium of claim 13, wherein the first set of initial correspondence points and the second set of initial correspondence points are obtained by:
using a rectangle to surround the overlap area, and dividing the rectangle into a plurality of sub-rectangles;
determining two projective points on the first curved surface and the second curved surface projected by a center point of each of the plurality of sub-rectangles, and determining the two projective points corresponding to each of the plurality of sub-rectangle as a pair of correspondence points;
obtaining the first set of initial correspondence points and the second set of initial correspondence points in the first group of point clouds and the second group of point clouds according to the pair of correspondence points of each of the plurality of sub-rectangle.

17. The non-transitory computer-readable medium of claim 16, wherein the preset rule comprises calculating a distance between each pair of the correspondence points in the first set of initial correspondence points and the second set of initial correspondence points, and deleting the pair of the correspondence points from the first set of initial correspondence points and the second set of initial correspondence points when the distance between the pair of the correspondence points is larger than or equal to a preset threshold value.

18. The non-transitory computer-readable medium of claim 13, wherein the method further comprises:
identifying an overlap area of the second jointed point clouds where the converted first group of point clouds overlaps with the second group of point clouds;
simplifying and smoothing the overlap area of the second jointed point clouds by executing preset simplification methods and preset smoothing methods before displaying the second jointed point clouds on the display screen.
